(19) United States
(12) Patent Application Publication
(10) Pub. No.: US 2014/0215897 A1
(43) Pub. Date: Aug. 7, 2014

(54) APPARATUS TO BLOCK PEST MOBILITY AND LOCOMOTION

(71) Applicant: Kevin McAllister, New York, NY (US)

(72) Inventor: Kevin McAllister, New York, NY (US)

(21) Appl. No.: 13/757,716

(22) Filed: Feb. 1, 2013

(51) Int. Cl. A01M 1/10; A01M 1/20

(52) U.S. Cl. CPC A01M 1/103; A01M 1/20
USPC 43/107; 43/132.1; 43/131; 427/180

(57) ABSTRACT

An apparatus (10) that blocks the mobility and/or locomotion of insects by ensnaring the appendages of insects in a fiber (20) pattern.

### FIELD OF INVENTION

The present invention relates to pest control. More particularly, the present invention relates to reducing or preventing the mobility and/or locomotion of insects and to the trapping/killing of insects.

### BACKGROUND OF THE INVENTION

Many pests are particularly troubling to man. These include but are not limited to the bed bug, termite, cockroach, flea, tick, mosquito, etc. The bed bug, for example, has seen a resurgence in the last 10 years and is of particular trouble due to its tremendous resilience and increasing resistance to pesticides. Bed bugs feed on blood, cause itchy bites, and generally irritate human hosts. Although they are not known to transmit or spread disease, they can cause other public health problems. Consequently, preventing and/or controlling bed bugs is a real public health concern. Recently publicized incidents of bed bug infestations in the United States indicate that public pest control practices may be ineffective. Chemical methods to prevent and/or control bed bug infestations can be costly, complex, and limited in usefulness as bed bugs' resistance to pesticides increase over time. There are few widely-used non-chemical methods that attempt to reduce bedbug infestations (for example, encasement of bedding). However, none actually prevent infestation or prevent feeding but simply force bed bugs to live and breed farther from the food source. In the case of mattress covers, bed bugs simply nest in the bed frame or behind wall hangings or other furniture close to the bed, emerge at night, crawl to the sleeping host, feed and return to their hiding place once engorged.

Bed bugs are approximately 4-5 millimeters long. They are broad and flat in shape, brown in color, and glisten from a distinctive, smelly oil secreted from scent glands. The wings are scale-like and vestigial. Females lay about 200 or more eggs during reproductive periods, and can lay around a thousand eggs during several such periods within a year. Bed bugs do not mature and procreate without feeding. Bed bugs feed chiefly at night in the wild. They feed on the blood of birds and small mammals, and within human-inhabited areas they feed upon domesticated animals as well as man. They retreat to their hiding places during the daytime, using up to several days in which to digest their food. Most bed bugs live full time within eight feet of where humans sleep. When hiding they are generally found in bedding and mattresses (hence the name), nearby furniture, carpeting, within dressers and clothes, curtains, and cushions.

It would be advantageous to have a low cost, passive, and chemical-free method to prevent and/or control insect pests, such as bed bugs from feeding on humans or other mammals such as household pets. It would be advantageous to have a method to prevent and/or control insect pests that exploit weaknesses in how insects live and grow.

### SUMMARY OF THE INVENTION

An embodiment of the invention obviates the above problems by providing an apparatus that controls the mobility of insects, comprising a substrate having a top surface, a bottom surface, and a side surface that connects the top and bottom surfaces and a plurality of entangling fibers situated on one of the respective surfaces, said plurality of entangling fibers forming at least one opening therein sized and shaped to allow for easy entrance of the initial bulk of an insect appendage and for loose fitting around the remainder of the insect appendage. The plurality of entangling fibers may be configured as interlaced fibers. In such case, the interlaced fibers may be configured as intersecting fiber filaments or as interconnected loops. The interlaced fibers may be formed to be fixedly interconnected. The plurality of entangling fibers may be configured as a series of adjacent, parallel fibers. The series of adjacent, parallel fibers may be formed to spread upon contact pressure with an insect and an opening between two respective adjacent, parallel fibers is formed upon a spreading of the two respective adjacent, parallel fibers.

The apparatus may further comprise a nanoparticle situated on a respective fiber that is adapted, upon contact with a respective insect, to pass from the respective fiber and through the exoskeleton of the respective insect. The nanoparticle may comprise a toxin, a coagulant, or a combination of a toxin and a coagulant.

The plurality of entangling fibers may be configured to project from the top surface so as to permit a respective insect appendage to easily engage and enter the at least one opening. Also, the respective surface having the plurality of entangling fibers situated thereon may be formed to have an irregular surface so as to create a space or spaces underneath the entangling fibers. The space or spaces underneath the entangling fibers may be sized and shaped so as to permit a respective insect appendage to pass through the at least one opening that overlies the space or spaces.

Another embodiment of the invention provides an apparatus to impede the locomotion of insects, comprising a substrate and an entangling pad of fibers located on a respective surface of the substrate, said entangling pad being configured with a plurality of pad openings therethrough which are dimensioned to capture an insect appendage during the movement of a respective insect on the substrate. The entangling pad of fibers may be configured as an interwoven pad of fibers. In such case, the interwoven pad of fibers may be configured as a plurality of intersecting fiber filaments or as a plurality of interconnected loops. The entangling pad of fibers may be configured as a series of adjacent, parallel fibers. The series of adjacent, parallel fibers may be formed to spread upon contact pressure with a respective insect and a pad opening between two respective adjacent, parallel fibers is formed upon a spreading of the two respective adjacent, parallel fibers.

The apparatus may further comprise a plurality of nanoparticles situated within the entangling pad of fibers that are each adapted, upon contact with a respective insect, to pass from the entangling pad of fibers and through the exoskeleton of the respective insect. The nanoparticles may comprise a toxin, a coagulant, or a combination of a toxin and a coagulant.

The entangling pad of fibers may be configured to project from the respective surface of the substrate to permit an insect appendage to pass through a respective pad opening. Also, the respective surface having the entangling pad of fibers located thereon may be formed to have an irregular surface so as to create a space or spaces underneath the entangling pad of fibers. The space or spaces underneath the entangling pad of fibers may be dimensioned to permit a respective insect appendage to pass through a respective pad opening.

Another embodiment of the invention provides a method of impeding the movement of insects, comprising the steps of forming an entangling fiber structure on a surface of a substrate; configuring the entangling fiber structure with a plurality of openings therethrough which are dimensioned to capture an insect appendage during movement of a respective insect on the substrate; and creating a spacing between the entangling fiber structure and at least one portion of the respective surface having the entangling fiber structure formed thereon so as to permit a respective insect appendage to pass through a respective opening that overlies the spacing. The method may further comprise the step of situating a plurality of nanoparticles on the entangling fiber structure that are adapted, upon contact with a respective insect, to pass from the structure and through the exoskeleton of the respective insect, said nanoparticles comprising a toxin, a coagulant, or a combination of a toxin and a coagulant.

Another embodiment of the invention provides a method of constructing a structure that impedes the movement of insects, comprising the steps of providing a substrate; forming a plurality of entangling fibers on a respective surface of the substrate; and configuring the plurality of entangling fibers with a plurality of openings therethrough which are dimensioned to capture an insect appendage during the movement of a respective insect on the substrate. The forming step may comprise forming a plurality of entangling fibers that project from the respective surface of the substrate to permit the insect appendage to pass through a respective opening. The providing step may comprise providing a substrate having an irregular surface and the forming step may comprise forming the plurality of entangling fibers on the irregular surface so as to create space or spaces underneath the plurality of entangling fibers that are dimensioned to permit the insect appendage to pass through a respective opening. The forming step may comprise spinning polymer as a raw material for the fibers and depositing resulting fiber filaments onto the respective surface of the substrate. The forming step may comprise utilizing a melt-blowing process to deposit resulting fiber filaments onto the respective surface of the substrate.

### DESCRIPTION OF THE DRAWINGS

For a better understanding of the present invention, reference is made to the following description of an exemplary embodiment thereof, and to the accompanying drawings, wherein:

FIG. 1(a) is an oblique perspective of an apparatus constructed in accordance with an embodiment of the present invention;

FIG. 1(b) is an oblique perspective of another apparatus constructed in accordance with an embodiment of the present invention;

FIG. 2(a) is a side or cross-sectional view of the apparatus of FIG. 1(b);

FIG. 2(b) is a side or cross-sectional view of an alternative apparatus of the present invention;

FIG. 2(c) is a magnified view of a portion of the apparatus of FIG. 2(b);

FIG. 3(a) is an illustration of an insect in contact with an apparatus of the present invention;

FIG. 3(b) is an illustration of an insect in contact with a second apparatus of the present invention;

FIG. 4(a) is an illustration of a typical progression of an insect leg's contact with the apparatus of FIG. 3(a);

FIG. 4(b) is an illustration of a typical progression of an insect leg's contact with the second apparatus of FIG. 3(b); and

FIGS. 5(a) and 5(b) are illustrations of an insect in contact with a third apparatus of the present invention.

### DETAILED DESCRIPTION

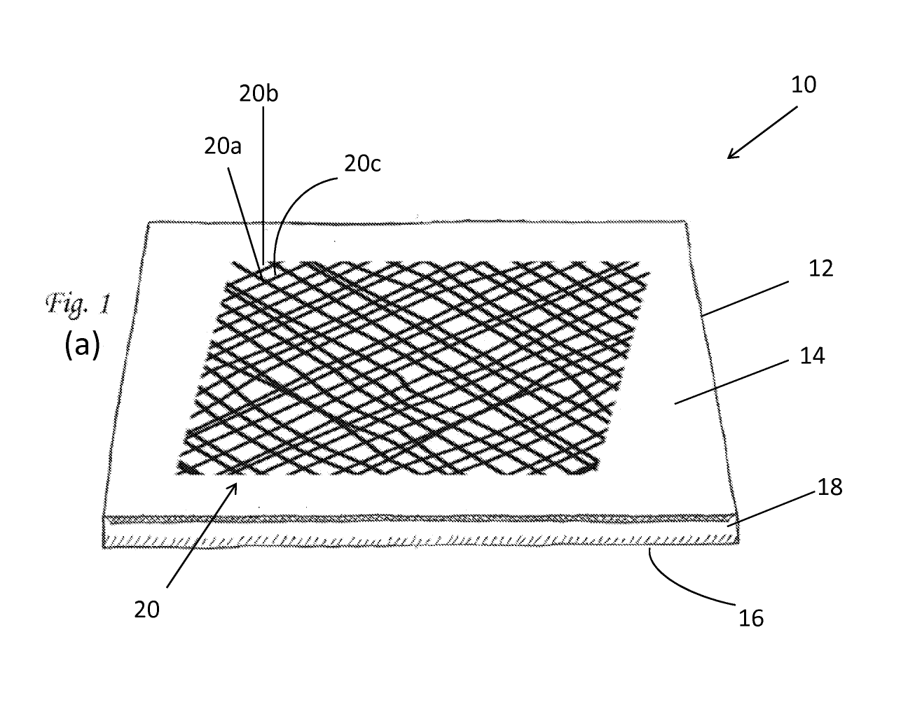

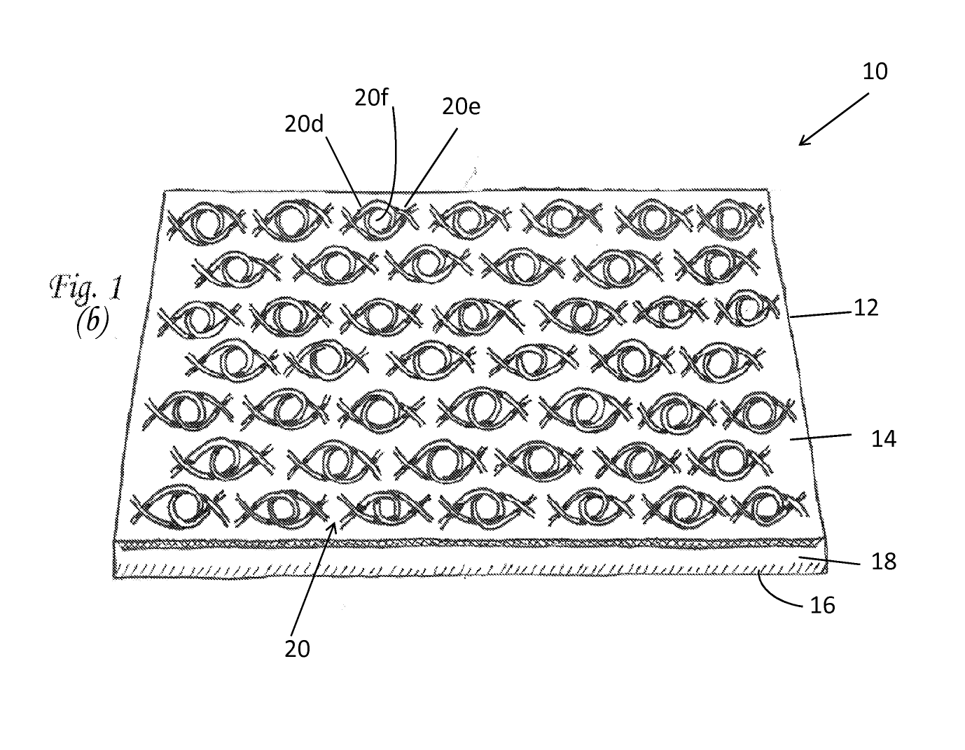

FIG. 1(a) shows an apparatus 10 constructed in accordance with an embodiment of the present invention. The apparatus 10 comprises a substrate 12 having a top surface 14, a bottom surface 16, and a side surface (or surfaces) 18 that connects the top surface 14 with the bottom surface 16. The figure shows the substrate 12 and surfaces 14, 16, 18 as rectilinear although they each may be configured to take on other shapes and forms. The surfaces 14, 16, 18 are each shown as generally flat in this figure although a respective surface may be configured differently. The substrate 12 may be formed of any material appropriate for a respective application of the apparatus 10 as will be described in further detail.

The substrate 12 is configured to have a plurality of entangling fibers 20 situated on the top surface 14. It is noted that the substrate 12 may be configured to have the fibers 20 situated on any particular surface 14, 16, 18. The fibers 20 may be composed of synthetic material, naturally occurring material or a combination of both. The fibers 20 may be formed on a respective surface by various manners, as will be detailed below.

As shown in FIG. 1(a), the entangling fibers 20 are configured as cross connected fibers in a general crosshatch pattern, i.e., two series of intersecting fibers 20a, 20b with openings 20c formed therebetween. The intersecting fibers 20a, 20b may be formed to be fixedly or non-fixedly interconnected. The intersecting fibers 20a, 20b form respective openings 20c which are each sized and shaped to allow for easy entry of the initial bulk of an insect appendage (e.g., the claw and the tarsus of a bed bug leg) and for loose fitting around the remainder of the appendage. To specifically accommodate a bed bug leg, each opening 20c may be at least approximately 0.25 mm across its width. To accommodate other insects or other appendages, each opening 20c may be sized differently. In the case the intersecting fibers 20a, 20b are not formed to be fixedly interconnected, it understood that each opening 20c may have a variable width that changes due to insect contact, substrate 12 movement, etc. The range of the variable width may include therein a width of approximately 0.25 m. It is understood that the openings 20c are not required to each have the same sized and shaped widths. It is also understood that, as shown in the figure, each of the two series of intersecting fibers 20a, 20b are not required to be comprised of parallel fiber lines.

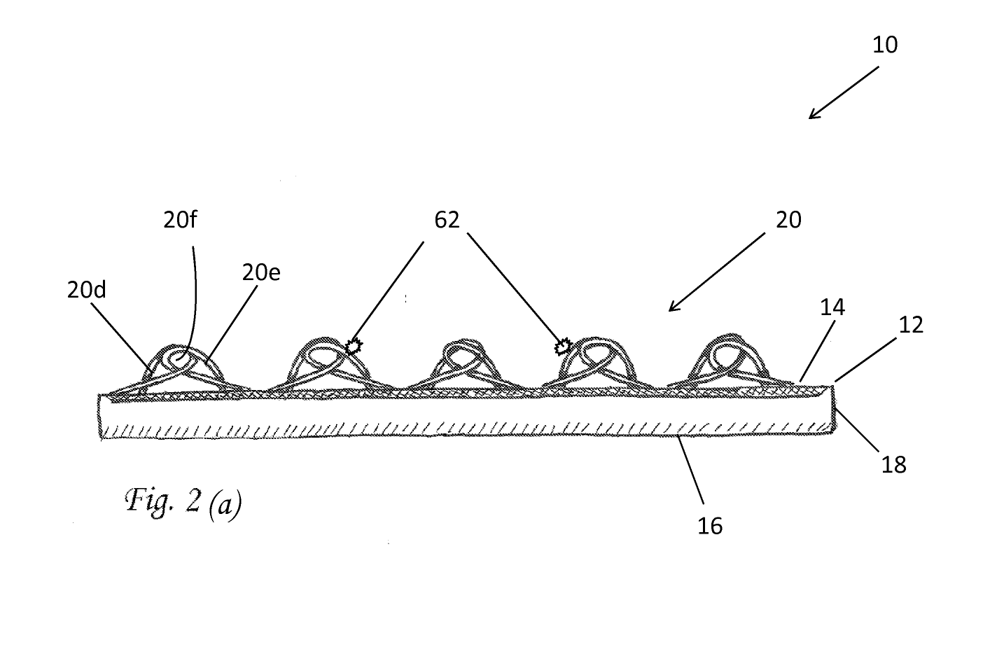

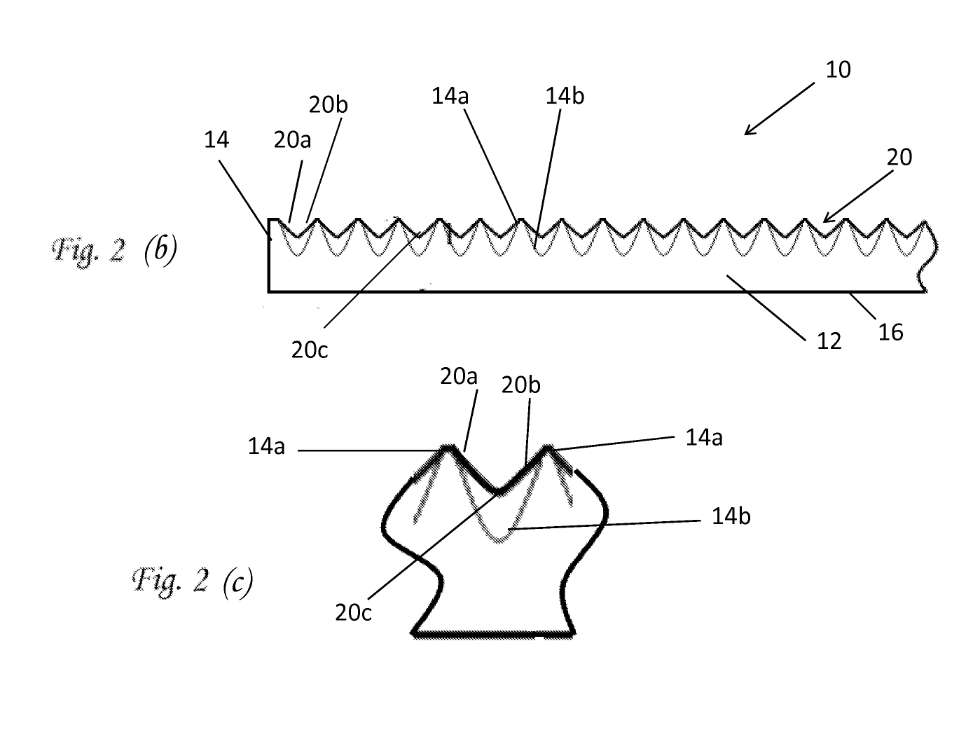

The apparatus 10 may have the cross connected fibers configured in a different interlaced pattern/structure. The other interlaced patterns/structures that may be formed by the fibers 20 also have respective openings that may be sized and shaped similar to the openings 20c of the intersecting fibers 20a, 20b and that function in the same or similar manner. For example, FIG. 1(b) shows the apparatus 10 of FIG. 1(a) with cross connected fibers configured as interconnected loops 20d, 20e (also called a loop pair) with an opening 20f formed therebetween. FIG. 2(a) is a side or a cross-sectional view of the apparatus 10 that shows further detail of the cross connected fibers configured to form interconnected loops 20d, 20e Like the intersecting fibers 20a, 20b, the interconnected loops 20d, 20e may be formed to be fixedly or non-fixedly interconnected. The fibers 20 may also be configured to form stand alone loops or other interlaced patterns/structures. Like the intersecting fibers 20a, 20b above, the interconnected loops 20d, 20e form an opening 20f sized and shaped to allow for easy entry of the initial bulk of a an insect appendage (e.g., the claw and the tarsus of a bed bug leg) and for loose fitting around the remainder of the appendage. Typically, the opening 20f may be rounded in shape. To specifically accommodate a bed bug leg, each opening 20f may be at least approximately 0.25 mm across its width. To accommodate other insects or other appendages, each opening 20c may be sized differently. In the case the loops 20d, 20e are not formed to be fixedly interconnected, it understood that each opening 20f may have a variable width that changes due to insect contact, substrate 12 movement, etc. The range of the variable width may include therein a width of approximately 0.25 m. It is understood that the openings 20f are not required to each have the same sized and shaped widths. The fibers 20 may also be configured to form multiple interconnected or interlaced loops that form openings 20f and added entangling features.

It is noted that intersecting fibers 20a, 20b, the interconnected loops 20d, 20e or other interlaced patterns/structures generally form an interwoven pad which can be made to any size or shape. Regardless of shape or size, the intersecting fibers 20a, 20b, the interconnected loops 20d, 20e, or other interlaced patterns/structures are formed to trap bed bugs and/or other insects through entanglement of the legs or other appendages of the insects. To aid in the entanglement, the intersecting fibers 20a, 20b, the interconnected loops 20d, 20e, or other interlaced patterns/structures (and the respective openings) project a certain distance from the top surface 14 to permit an insect appendage to easily engage and enter a respective opening during an insect's normal contact with, or movement on, the top surface 14. This is illustrated in FIG. 2(a) which shows a projection of the loop pairs (and the respective openings 20f). The projection by the particular interlaced pattern/structure may be accomplished, for example, by the use of an appropriate material for the fibers 20, by an appropriate configuration of the fibers 20 in the respective interlaced pattern/structure, by the means of situating the fibers 20 on the top surface 14, or some combination of the preceding. The projection distance of the respective interlaced pattern/structure must be sufficient to permit the insect appendage (e.g., the claw, the tarsus, and some portion of the remainder of a bed bug leg) to pass through a respective opening. For example, the projection distance may be at least approximately 0.25 mm-0.30 mm which is the average length of the end segment of a bed bug's leg. It is understood that the projection distance is not required to be equal along the extent of the particular interlaced pattern/structure.

As an alternative to a projection, the top surface 14 may be configured with openings or an irregular surface so as to provide space or spaces underneath the fibers 20 as they rest on the top surface 14. An example is shown in FIGS. 2(b) and 2(c) which illustrate the entangling fibers 20 configured as intersecting fibers 20a, 20b resting atop the top surface 14. The top surface 14 is configured with an undulating surface that has peaks 14a and cavities 14b formed in between the peaks 14a. The respective openings 20c formed by the intersecting fibers 20a, 20b are situated throughout the extent of the fibers 20 including at locations that overlie cavities 14b of the top surface 14. At those locations, the intersecting fibers 20a, 20b and the respective openings 20c will be spaced a certain distance from the bottom of the cavities 14b and permit an insect appendage to easily engage and enter a respective opening 20c during an insect's normal contact with, or movement on, the top surface 14. The top surface 14 may be configured with a variety of openings or irregular surfaces other than as shown, for example, a sawtooth surface. As noted above, the space or spaces underneath the fibers 20 must be of sufficient dimensions to permit the insect appendage (e.g., the claw, the tarsus, and some portion of the remainder of a bed bug leg) to pass through a respective opening. It is understood that the spaces of a plurality formed by the top surface 14 are not required to have the same dimensions.

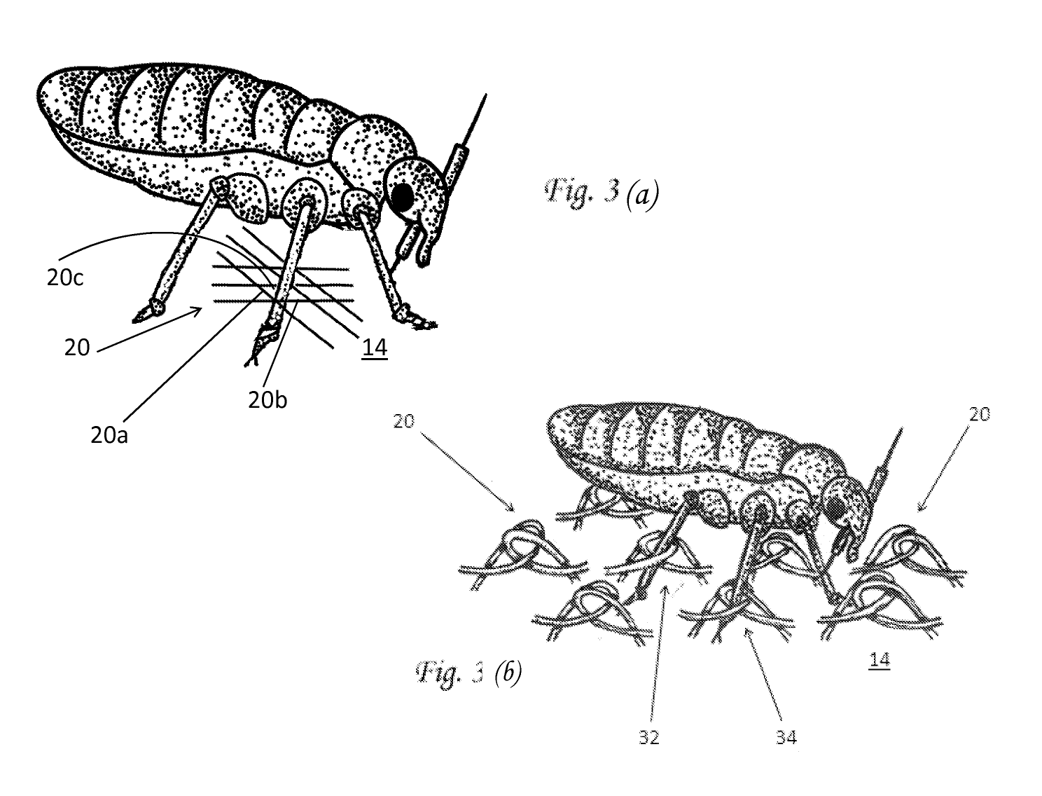

FIGS. 3(a) and 3(b) illustrate an insect in contact with the apparatus 10. FIG. 3(a) illustrates an insect standing among the entangling fibers 20 configured to form intersecting fibers 20a, 20b on the top surface 14 of the substrate 12. The insect has one of its legs placed through a respective opening 20c as a result of an insect's contact with, or movement on, the top surface 14. FIG. 3(b) illustrates an insect standing among the entangling fibers 20 configured to form loop pairs 32, 34 on the top surface 14 of the substrate 12. The insect has each of two legs placed through a respective loop pair 32, 34 as a result of an insect's contact with, or movement on, the top surface 14.

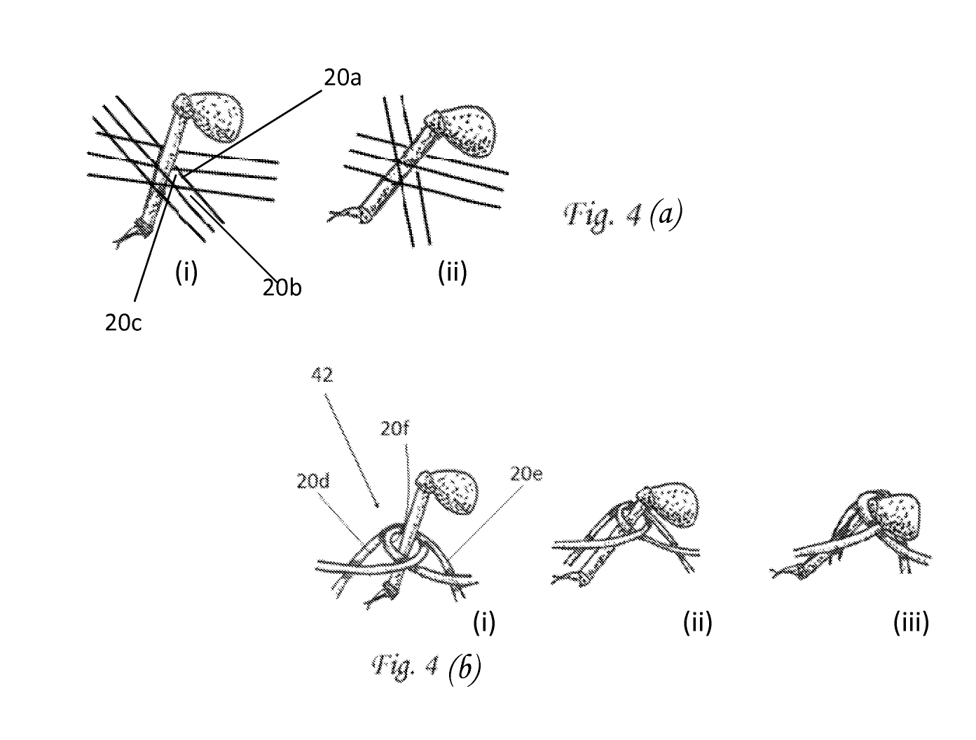

FIGS. 4(a) and 4(b) illustrate typical progressions of an insect's entanglement with the entangling fibers 20 configured as intersecting fibers 20a, 20b and interconnected loops 20d, 20e of a loop pair 42, respectively. FIG. 4(a)(i) shows the insect appendage after the initial bulk (e.g. a bed bug leg claw and tarsus) have entered through an opening 20c of intersecting fibers 20a, 20b. Once an insect appendage enters the opening 20c, the fibers 20a, 20b tend to slip up towards the thorax where the appendage joint meets the body. The projection distance of the opening 20c (or the dimensions of the spacing underneath the top surface 14), the length of the insect appendage and the appendage movement from the gait of the insect on the top surface 14 are some factors that determine how far the fibers 20a, 20b will move up the insect appendage. FIG. 4(a)(ii) shows the insect appendage after the insect has moved forward or away from the intersecting fibers 20a, 20b. The intersecting fibers 20a, 20b tend to move back down the appendage away from the thorax. Further, the intersecting fibers 20a, 20b tend to present a smaller opening 20c to the withdrawing insect appendage as the movement of the insect shifts the initial entry angle of the appendage relative to the intersecting fibers 20a, 20b and tends to pull the intersecting fibers 20a, 20b against the appendage. Similarly, FIG. 4(b)(i) shows the insect appendage after the initial bulk (e.g., a bed bug claw and tarsus) have entered through the opening 20f of the interconnected loops 20d, 20e. Upon an insect appendage entering the loops 20d, 20e, the loops 20d, 20e tend to slip up towards the thorax where the appendage joint meets the body. The projection distance of the loop pair 42 (or the dimensions of the spacing underneath the top surface 14), the length of the insect appendage and the appendage movement from the gait of the insect on the top surface 14 are some factors that determine how far the loops 20d, 20e will move up the bed bug leg. FIG. 4(b)(ii) shows the insect appendage after the insect has moved forward or away from the loop pair 42. The loops 20d, 20e tend to move back down the appendage away from the thorax. Further, the loops 20d, 20e tend to present a smaller opening 20f to the withdrawing insect appendage as the movement of the insect shifts the initial entry angle of the appendage relative to the loop pair 42 and tends to pull the loop pair 42 against the appendage.

FIG. 4(b)(iii) shows the insect appendage after the insect continues to move. The loops 20d, 20e entangle the appendage and prevent or restrict it from moving forward or away from the loop pair 42. The insect will now have considerable difficulty in withdrawing the appendage from the loop pair 42. Moreover, as the insect attempts to free itself, its other appendages are likely to become entangled by other interconnected loop pairs 42 in similar fashion to the point where the insect is substantially immobilized. For ease of visualization, the apparatus 10 is described and shown in FIG. 4(b)(iii) with reference to the fibers 20 configured with loop pairs 42. It is understood, however, the description applies equally or similarly to the apparatus 10 having the fibers 20 configured as intersecting fibers 20a, 20b or other interlaced patterns/structures.

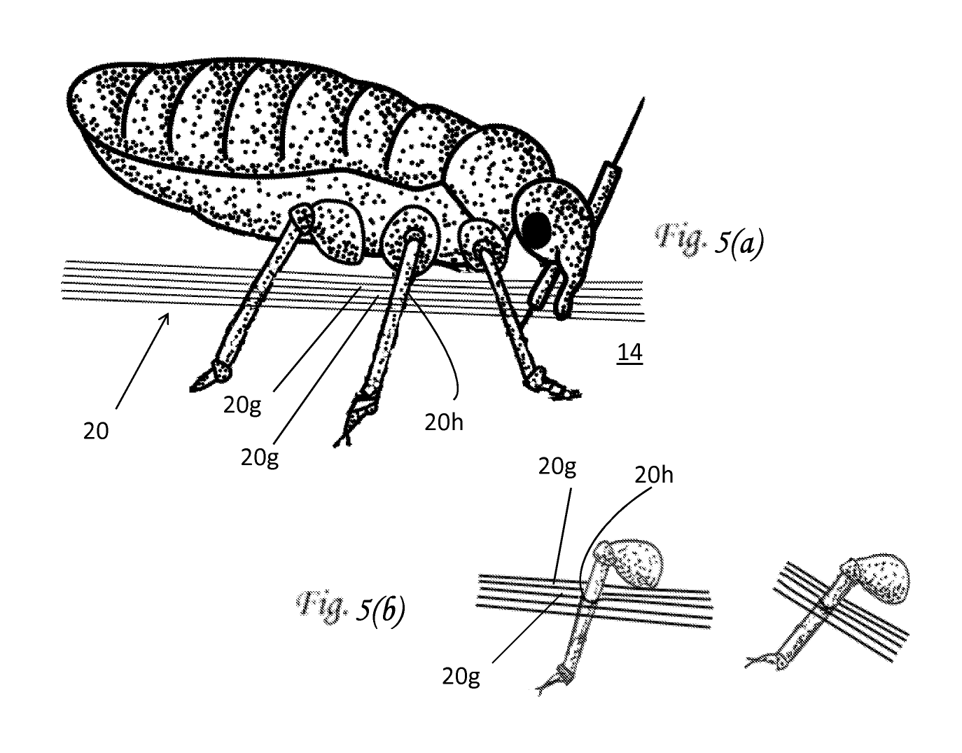

Instead of being configured as cross connected fibers in an interlaced pattern/structure, the entangling fibers 20 may be configured as series of adjacent, parallel fibers 20g. This is shown in FIGS. 5(a) and 5(b). The parallel fibers 20g are closely spaced with one another and may or may not be spaced uniformly. The parallel fibers 20g are formed as rigid or semi-rigid elements that may flex with pressure. In particular, the fibers 20g may be formed to spread upon contact pressure with an insect appendage. This may be conditioned for operational purposes, for example, upon the fibers 20 experiencing a certain amount of pressure or a defined pressure over a certain time of contact with an insect appendage. The parallel fibers 20g form openings or interstices 20h between each other. The interstices 20h are each sized and shaped to allow, upon a spreading of the respective fibers 20g, for entry of the initial bulk of an insect appendage (a bed bug leg claw and tarsus) and for close fitting around the remainder of the appendage. To specifically accommodate a bed bug leg, each interstice 20h may be adapted to expand at least approximately 0.25 mm from one fiber 29g to an adjacent one 20g. To accommodate other insects or other appendages, each interstice 20h may be sized differently.

The parallel fibers 20g generally form an entangling pad which can be made to any size or shape. Like the other above-described entangling fibers 20, the parallel fibers 20g are formed to trap bed bugs and/or other insects through entanglement of the legs or other appendages of the insects. Also, like the other above-described entangling fibers 20 and in the same way and manner, the parallel fibers 20g may be formed to project a distance from the top surface 14 sufficient to permit an insect appendage to easily engage and enter a respective interstice 20h during an insect's normal contact with, or movement on, the top surface 14. Further, like the other above-described entangling fibers 20 and in the same way and manner, the top surface 14 may be configured with openings or an irregular surface so as to provide space or spaces underneath the parallel fibers 20g as they rest on the top surface 14. In such case, respective interstices 20h are situated at locations that overlie cavities 14b of the top surface 14 to aid in an insect's entanglement.

FIGS. 5(a) and 5(b) illustrate an insect in contact with the apparatus 10 and, in particular, an insect standing among the parallel fibers 20g. The insect has one of its appendages placed through a respective interstice 20h as a result of an insect's contact with, or movement on, the top surface 14 Like the other above-described entangling fibers 20, once an insect appendage (e.g., a bed bug leg) enters a respective interstice 20h, the fibers 20g will move up towards the thorax where the appendage joint meets the body. The projection distance of the interstice 20g (or the dimensions of the spacing underneath the top surface 14), the length of the insect appendage and the appendage movement from the gait of the insect on the top surface 14 are some factors that determine how far the fibers 20g will move up the insect appendage. As the insect moves forward or away from the fibers 20g, the fibers 20g will move back down the appendage away from the thorax. Further, the fibers 20g will present a smaller opening by the respective interstice 20h to the withdrawing insect appendage as the movement of the insect shifts the initial entry angle of the appendage relative to the parallel fibers 20g and tends to pull the fibers 20g against the appendage. In addition, the fibers 20g that flexed to allow entry through the interstice 20g return to their original, relaxed state and close in on the captured insect appendage. As the insect continues to move, the unflexed fibers 20g entangle the appendage and prevent or restrict it from moving forward or away from the fibers 20g. The insect will now have considerable difficulty in withdrawing the appendage from the respective interstice 20h. Moreover, as the insect attempts to free itself, its other appendages are likely to become entangled by other interstices 20g in similar fashion to the point where the insect is substantially immobilized.

The entangling fibers 20 may be formed on a respective surface of the substrate 12 by various methods. A respective method can be calibrated to form intersecting fibers, loop pairs, stand alone loops, parallel fibers, or other entangling or interlaced patterns/structures, as described above (e.g., loops or interlaced fibers that may or may not be fixedly interconnected, projected openings, etc.). For example, the entangling fibers 20 may be formed by conventional methods that produce solid threads from solution, such as, electrospinning, electrospraying, or solution dry spinning. Electrospinning in particular is the production of polymer filaments using electrostatic force. In electrospinning, a high voltage is used to create an electrically charged jet of polymer solution or melt, which dries or solidifies to leave a polymer fiber on a suitable collecting substrate. The process produces ultra-fine fibers (with micrometer diameters), can utilize any one or more of a large variety of polymers to be the raw material(s), and forms a fine continuous filament on a substrate. Another method is melt-blowing which is a process for producing fibrous webs or articles directly from polymers or resins using high-velocity air or another appropriate force to attenuate the filaments. As is evident from the above description, some of the key considerations in forming the entangling fibers 20 and establishing an appropriate trapping mechanism include the relative dimensions of the insect appendages, the fibers 20, and the openings formed throughout. In addition, the entangling fibers 20 may be formed on the respective surface of the substrate 12 in a certain orientation that can strengthen the fibers and/or make the trapping mechanism more effective.

The following describes the construction of an apparatus 10 in accordance with an embodiment of the invention and the results of testing its operation. An aluminum substrate (or collector) with an irregular top surface that resembles an accordion-like, pleated fan was selected as the substrate for the apparatus 10. Although not a key construction or operating parameter, the thickness of the fiber was selected to be approximately 1 micron. A conventional electrospinner was used to spin 1 micron polymer as the raw material and deposit resulting fiber filaments onto a portion of the top surface of the aluminum substrate. The fiber was formed as intersecting fiber filaments that rested atop the top surface without any projection of its respective openings. The configuration of the top surface provided spaces underneath the intersecting fiber filaments. In a first test, live bed bugs were set down on the fiber portion of the top surface and their mobility and locomotion were observed. Certain of the bed bugs stopped immediately when some of their legs entered into the openings in the intersecting fibers pattern and they were unable to extract their legs. It was also observed that, as these bed bugs struggled to withdraw their entangled legs, more legs got caught by entering into other openings in the intersecting fibers pattern. All of the bugs employed during the test became substantially immobilized and some tore appendages off their torso while unsuccessfully attempting to extricate themselves from the fibers. No bugs were able to move in any direction any distance while entangled in the fibers. In a second test, live bed bugs were set down on the intersecting fibers and on a portion of the top surface without the fibers deposited thereon. It was observed that the bed bugs on the fiber portion of the top surface walked slower across the top surface than their counterparts on the non-fiber portion of the top surface. Further, the bed bugs on the fiber portion of the top surface appeared to walk slower and slower across the top surface as they struggled to withdraw their legs from the fiber pattern.

Advantageously, the present invention provides an apparatus 10 specifically designed to reduce or prevent the movement of bed bugs and other insects. The apparatus 10 is specifically designed with the intention of entangling and/or ensnaring these pests in relation to their legs or other appendages. Once entangled or ensnared, the pests will be prevented from reaching their targets to feed or will be hindered in reaching their targets which may then have moved in the interim. Moreover, the pests may eventually die from the failure to feed for certain time.

The apparatus 10 may further comprise nanoparticles 62 (i.e., ultrafine particles that are sized between 1 and 100 nanometers) located on the surface of each of the plurality of entangling fibers 20. This is illustrated in FIG. 2(a), as an example, although the dimensions of the nanoparticles 62 relative to the fibers 20 are enlarged to be viewable in the figure. The nanoparticles 62 may be secured to the fibers 20 using a variety of methods, for example, the nanoparticles may be infused into the material of the fibers 20. Regardless of the method, the nanoparticles 62 are formed to “break off” the fibers 20 as an insect moves around on the fiber material in attempts to free itself from an entanglement with the fibers 60. The nanoparticles 62 are sized and shaped so as to pass through the exoskeleton of an insect and enter the insect's body and/or internal organs. The nanoparticles 62 comprise specific material(s) that may be harmful to an insect, such as toxins or, particularly for bed bugs, coagulants. Once a nanoparticle 62 enters an insect's body, the toxins may take effect and kill the pest. In the case of bed bugs, if a bed bug somehow escapes entanglement with the fibers 20 and makes it to its target to feed, the coagulants may gel the ingested blood inside the bed bug to the point of killing the pest. The nanoparticles 62 may comprise either or both toxins and coagulants.

Other modifications are possible within the scope of the invention. For example, the apparatus 10 is not limited to impeding bed bugs but may be used for other insects as well, such as cockroaches, termites, etc. Also, the apparatus 10 is not limited to walking insects but may be used for flying insects that may land within the fibers 20 or fly along the top surface 14 sufficiently close to get entangled with the fibers 20. Also, the apparatus 10 may be constructed as a stand-alone product or as part of a larger insect trap product, such as a closed container that permits entry by an insect.

The apparatus 10 may take on the form of a floor covering (e.g., wall-to-wall carpeting, mats, etc.) where the backing of the covering functions as the substrate 12 and the covering/carpet fibers comprise the fibers 20 described above. Alternatively, an existing floor covering/carpet may be modified to have the fibers 20 infused or interweaved with existing covering/carpet fibers. Similarly, the apparatus 10 may take on the form of a wall covering (e.g., wall paper, wainscoting, etc.) where the backing of the covering functions as the substrate 12 and the face of the covering comprise the fibers 20 described above (e.g., using imprinted face designs).

The apparatus 10 may also take on the form of wall insulation. For example, for either soft roll insulation or hard insulation types, one of the paper facings for the insulation material in combination with the insulation material may function as the substrate 12 and the other paper facing for the insulation material may comprise the fibers 20 described above. As an alternative, the central insulation material itself may function as the substrate 12 and the paper facing for the insulation material (on either or both sides of the insulation material) may comprise the fibers 20. Similarly, the apparatus 10 may take on the form of bedding accessories such as valences, covers, sheets and other bedding material. In such case, the fabric itself may function as the substrate 12 and a fabric surface may comprise the fibers 20.

It is also understood that the apparatus 10 can be formed by an application of the fibers 20 described above on a particular surface that may function as a substrate 12 (such as, the infusing or interweaving fibers 20 with existing covering/carpet fibers of an existing floor covering/carpet noted above). As an example, the fibers 20 may be sprayed onto a desired surface (for example, wall board, flooring base, foundation wall, etc.) The desired surface may include stationary surfaces as wells moveable surfaces that can then be placed in desired locations.

What is claimed is:

1. An apparatus that controls the mobility of insects, comprising a substrate having a top surface, a bottom surface, and a side surface that connects the top and bottom surfaces and a plurality of entangling fibers situated on one of the respective surfaces, said plurality of entangling fibers forming at least one opening therein sized and shaped to allow for easy entrance of the initial bulk of an insect appendage and for loose fitting around the remainder of the insect appendage.

2. The apparatus of claim 1, wherein the plurality of entangling fibers are configured as interlaced fibers.

3. The apparatus of claim 2, wherein the interlaced fibers are configured as intersecting fiber filaments.

4. The apparatus of claim 2, wherein the interlaced fibers are configured as interconnected loops.

5. The apparatus of claim 2, wherein the interlaced fibers are formed to be fixedly interconnected.

6. The apparatus of claim 1, wherein the plurality of entangling fibers are configured as a series of adjacent, parallel fibers.

7. The apparatus of claim 6, wherein the series of adjacent, parallel fibers are formed to spread upon contact pressure with an insect and an opening between two respective adjacent, parallel fibers is formed upon a spreading of the two respective adjacent, parallel fibers.

8. The apparatus of claim 1, wherein the plurality of entangling fibers are configured to project from the top surface so as to permit a respective insect appendage to easily engage and enter the at least one opening.

9. The apparatus of claim 1, further comprising a nanoparticle situated on a respective fiber that is adapted, upon contact with a respective insect, to pass from the respective fiber and through the exoskeleton of the respective insect.

10. The apparatus of claim 9, wherein the nanoparticle comprises a toxin, a coagulant, or a combination of a toxin and a coagulant.

11. The apparatus of claim 1, wherein the respective surface having the plurality of entangling fibers situated thereon is formed to have an irregular surface so as to create a space or spaces underneath the entangling fibers.

12. The apparatus of claim 11, wherein the space or spaces underneath the entangling fibers are sized and shaped so as to permit a respective insect appendage to pass through the at least one opening that overlies the space or spaces.

13. An apparatus to impede the locomotion of insects, comprising a substrate and an entangling pad of fibers located on a respective surface of the substrate, said entangling pad being configured with a plurality of pad openings therethrough which are dimensioned to capture an insect appendage during the movement of a respective insect on the substrate.

14. The apparatus of claim 13, wherein the entangling pad of fibers is configured as an interwoven pad of fibers.

15. The apparatus of claim 14, wherein the interwoven pad of fibers is configured as a plurality of intersecting fiber filaments.

16. The apparatus of claim 14, wherein the interwoven pad of fibers is configured as a plurality of interconnected loops.

17. The apparatus of claim 13, wherein the entangling pad of fibers is configured as a series of adjacent, parallel fibers.

18. The apparatus of claim 17, wherein the series of adjacent, parallel fibers are formed to spread upon contact pressure with a respective insect and a pad opening between two respective adjacent, parallel fibers is formed upon a spreading of the two respective adjacent, parallel fibers.

19. The apparatus of claim 13, wherein the entangling pad of fibers is configured to project from the respective surface of the substrate to permit an insect appendage to pass through a respective pad opening.

20. The apparatus of claim 13, further comprising a plurality of nanoparticles situated within the entangling pad of fibers that are each adapted, upon contact with a respective insect, to pass from the entangling pad of fibers and through the exoskeleton of the respective insect.

21. The apparatus of claim 20, wherein the nanoparticles comprise a toxin, a coagulant, or a combination of a toxin and a coagulant.

22. The apparatus of claim 13, wherein the respective surface having the entangling pad of fibers located thereon is formed to have an irregular surface so as to create a space or spaces underneath the entangling pad of fibers.

23. The apparatus of claim 22, wherein the space or spaces underneath the entangling pad of fibers are dimensioned to permit a respective insect appendage to pass through a respective pad opening.

24. A method of impeding the movement of insects, comprising the steps of forming an entangling fiber structure on a surface of a substrate; configuring the entangling fiber structure with a plurality of openings therethrough which are dimensioned to capture an insect appendage during movement of a respective insect on the substrate; and creating a spacing between the entangling fiber structure and at least one portion of the respective surface having the entangling fiber structure formed thereon so as to permit a respective insect appendage to pass through a respective opening that overlies the spacing.

25. The method of claim 24, further comprising the step of situating a plurality of nanoparticles on the entangling fiber structure that are adapted, upon contact with a respective insect, to pass from the structure and through the exoskeleton of the respective insect, said nanoparticles comprising a toxin, a coagulant, or a combination of a toxin and a coagulant.

26. A method of constructing a structure that impedes the movement of insects, comprising the steps of:
a. providing a substrate;
b. forming a plurality of entangling fibers on a respective surface of the substrate; and
c. configuring the plurality of entangling fibers with a plurality of openings therethrough which are dimensioned to capture an insect appendage during the movement of a respective insect on the substrate.

27. The method of claim 26, wherein the forming step comprises forming a plurality of entangling fibers that project from the respective surface of the substrate to permit the insect appendage to pass through a respective opening.

28. The method of claim 26, wherein the providing step comprises providing a substrate having an irregular surface and the forming step comprises forming the plurality of entangling fibers on the irregular surface so as to create space or spaces underneath the plurality of entangling fibers that are dimensioned to permit the insect appendage to pass through a respective opening.

29. The method of claim 26, wherein the forming step comprises spinning polymer as a raw material for the fibers and depositing resulting fiber filaments onto the respective surface of the substrate.

30. The method of claim 26, wherein the forming step comprises utilizing a melt-blowing process to deposit resulting fiber filaments onto the respective surface of the substrate.
